(19) United States
(12) Patent Application Publication
(10) Pub. No.: US 2010/0138323 A1
(43) Pub. Date: Jun. 3, 2010

(54) FLEXIBLE CORRESPONDENCE SOLUTION ENHANCING STRAIGHT-THROUGH PROCESSING IN TREASURY SYSTEMS

(75) Inventors: Ramesh Narasimha Gowda, Bangalore (IN); Harald Rodel, Wiesloch (DE); Sonke Jarre, Nussloch (DE); Anand Shankar, Jamshedpur (IN); Arndt Koester, Wiesloch (DE); Lavanya Anand, Bangalore (IN)

Correspondence Address: KENYON & KENYON LLP, 1500 K STREET N.W., WASHINGTON, DC, 20005, US

(73) Assignee: SAP AG, Walldorf (DE)

(21) Appl. No.: 12/326,033

(22) Filed: Dec. 1, 2008

(51) Int. Cl. G06Q 10/00; G06F 15/16

(52) U.S. Cl. 705/30; 709/230

(57) ABSTRACT

A system and method for sending and receiving data between a treasury system and a partner/recipient. In an embodiment, the sending system selects an outgoing channel and an outgoing message format based on the data and a predefined profile associated with the recipient, creates an outgoing message by using predefined mapping rules associated with the profile to map the data to the outgoing message format, and transfers the outgoing message to the outgoing channel through an adapter corresponding to the outgoing channel, which is programmed to perform predefined sending functions corresponding to the outgoing message format. In an embodiment, the receiving system receives the data into a messaging interface within the treasury system, extracts the logical messages from the received data, selects an incoming message format based on the received data, creates an incoming message from each logical message by using predefined mapping rules associated with the incoming message format to map the logical message from the incoming message format to a predefined treasury system format, and performs a function based on each incoming message.

### CROSS-REFERENCE TO RELATED APPLICATIONS

This application is related to U.S. patent application Ser. No. 12/199,775, filed Aug. 27, 2008, entitled “System and Method for Exposure Management.”

### COPYRIGHT AND LEGAL NOTICES

A portion of the disclosure of this patent document may contain material which is subject to copyright protection. The copyright owner has no objection to the facsimile reproduction by anyone of the patent document or the patent disclosure as it appears in the Patent and Trademark Office patent files or records, but otherwise reserves all copyrights whatsoever.

### BACKGROUND

Business entities, e.g., banks, enter into a large number of transactions in the ordinary course of their operations. Treasury systems allow a business user to conduct transactions involving a variety of financial instruments. For example, a corporation may employ a treasury system to invest surplus or to acquire loans in case of a deficit. A corporation may also employ a treasury system to comply with hedging guidelines such as International Financial Reporting Standard 39, Financial Instruments: Recognition and Measurement, promulgated by the International Accounting Standards Board, or Financial Accounting Statement 133, Accounting for Derivative Instruments and Hedging Activities, promulgated by the Financial Accounting Standards Board. For example, a treasury system may be used to evaluate financial risk or to purchase financial instruments such as securities which may be used as hedging instruments. Treasury systems may also aid in implementing corporate actions such as dividend distributions.

Each transaction or “deal” described above—such as a purchase, sale, or corporate action—requires a legal correspondence between two parties, such as a buyer and seller. This correspondence may take place, for example, by telephone, fax, postal mail, e-mail, or over the Internet.

FIG. 1 illustrates an existing treasury system 100 which uses Correspondence Objects (“COs”) 130 to manage messages sent between Company and Partner/Recipient (such as a buyer and seller). In this model, Company User 101a or 101b uses Terminal 102a or 102b to access the treasury system on Company Server 104 over Network 103. Company Server 104 accesses Partner-specific Channel 105-109 over Network 103. As used herein, “channel” describes how a message is received from or transmitted to a given partner/recipient. Example channels include File 105 (used, for example, to send and receive SWIFT messages), E-mail 106, Fax 107, Telephone 108, and Printer 109 (used, for example, to send and receive messages via postal mail). A variety of network topologies are well known for such treasury systems 100; the number of terminals 102, the number of servers 104, the number of channels 105-109, and differences in network topologies are immaterial to the foregoing description unless mentioned herein.

As shown in FIG. 1, the treasury system on Company Server 104 comprises Messaging Interface 110, Correspondence Monitor 120, and Alert Monitor 150. Messaging Interface 110 is an interface between Correspondence Monitor 120 and the middleware or storage used to send and receive individual messages related to treasury transactions. The protocol for sending or receiving a particular message depends on several factors, including the message's function, format, and channel. As used herein, “function” describes the purpose of a message (e.g., “Order to Buy or Sell”), and “format” describes a message's syntactical and semantic structure (e.g., MT502, which is the SWIFT message definition for the function “Order to Buy or Sell”). The Correspondence Monitor 120 is an interface for monitoring and manual processing of all Correspondence Objects 130, which contain the data needed to create and maintain messages during the correspondence process. Each CO 130 is assigned to one Deal 140, which represents a transaction as described above. Finally, Alert Monitor 150 creates internal messages to notify the user of outstanding issues, for example that a CO has not been sent within a defined time frame or that a CO has not been counter-confirmed within a defined time frame.

Available systems allow users to customize message formats and communication channels. Although “standard” messaging formats exist, customers may adapt these standard formats to comply with government- or recipient-specified content requirements, creating different “flavors” of the same standard. Current initiatives such as ISO to define a “universal standard” have so far proven problematic—and with no guarantee that every user will adhere perfectly to the result. Similarly, users may define channels to take advantage of existing communication paths with partner/recipients. Thus, messages may conform to any of multiple “standard” formats or be sent over any of multiple communication channels.

Available treasury systems also create and maintain COs automatically based on activity conducted within the system. In this way, treasury systems facilitate straight-through processing by automating correspondence between a company and a partner. As an example, a partner's treasury system may automatically generate a confirmation acknowledging a successful purchase order from a company. In turn, the company's treasury system may generate a counter-confirmation acknowledging the successful deal. Ideally, straight-through processing requires little or no manual intervention. However, current systems lack the flexibility to automatically accommodate customized message formats and communication channels without user intervention. For example, available systems support standard channels but may not support expansion, for example, to SMS communication channels. Thus, manual steps are currently required to complete processes if the company or the partner (or both) employ customized message formats or communication channels (or both).

Furthermore, available systems provide no mechanism for monitoring the correspondence life cycle. For example, an available system may send a purchase order request to a partner but will not recognize the corresponding incoming confirmation or error message nor use it to update the correspondence status.

These manual steps may introduce several negative consequences. For example, processes involving user intervention are difficult to reproduce for documentation and auditing purposes, hindering compliance with accounting regulations like the Sarbanes-Oxley Act (SOX). And, of course, a process and system requiring manual intervention adds time, effort, and risk of error not required by or present in a purely automated system.

Thus, the need exists for a flexible correspondence solution that accommodates different message formats and communication channels while automatically creating and maintaining COs to facilitate straight-through processing in treasury systems. The solution should also provide enhanced tools for approving transactions, monitoring transaction status, and managing and storing transaction details.

### SUMMARY OF INVENTION

Embodiments of the present invention enable users to flexibly define and implement new message formatting standards and communication channels. In example embodiments, the new architecture also provides enhanced functionality to adapt to different business processes and effectively manage the correspondence life cycle.

### BRIEF DESCRIPTION OF THE DRAWINGS

FIG. 1 is a block diagram of a system according to the prior art.

FIG. 2 is a block diagram of a system according to an embodiment of the present invention.

FIG. 3 is a flow chart that illustrates an example procedure performed to send an outgoing message, according to an embodiment of the present invention.

FIG. 4 is a flow chart that illustrates an example procedure performed to receive an incoming message, according to an embodiment of the present invention.

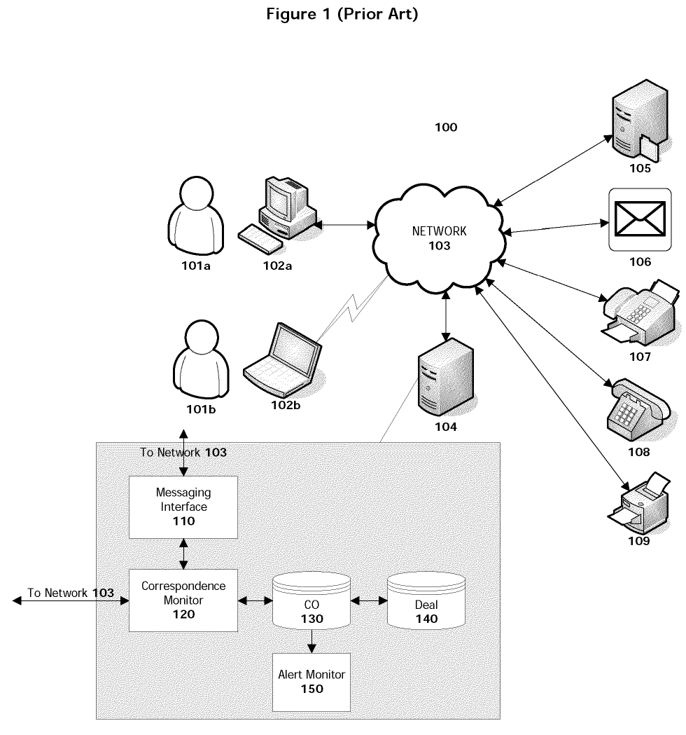

### DETAILED DESCRIPTION

Embodiments of the present invention relate to improved message support for straight-through processing in treasury systems. Example embodiments of the present invention provide a flexible correspondence system that supports a wide variety of formats and channels and provides SOX-compliant, audit-traceable straight-through processing for treasury deal confirmations.

Embodiments of the present invention provide flexible message formats in that a user may flexibly define mapping rules or tables at “exits” from different process steps or junctures. These mapping rules translate a user's output into a different format, for example a standard or agreed-upon format. In this way, a company and partner/recipient may agree on a “standard” format, even if their definition falls outside accepted standards. For example, the SWIFT body defines a meaning for each attribute of an MT566 (“Corporate Action Confirmation”) message. By configuring the message format and mapping rules, however, a company may change or misuse one or more attributes so long as the partner/recipient understands the message, either because the company has defined its mapping rules to translate its definitions into the partner/recipient's format or because the company and partner/recipient have previously agreed to use the company's format. Similarly, a company may alter the format of the form typically used to send and receive messages over E-mail, Fax, and Print channels.

In example embodiments, flexible message formatting allows a user to custom-build functionality to be triggered by certain events. For example, the user may program the system to automatically create a CO from an incoming message such as a SWIFT MTxxx message. COs may also be created manually, for example to reflect a fax or postal mail order. As another example, the user may program the system according to a user-defined business process to automatically settle a deal after receiving an appropriate counter-confirmation.

Example embodiments of the present invention also allow the user to define and change output channels depending on the partner/recipient. For example, a user may specify that Partner A should receive messages over E-mail, while Partner B should receive messages by Fax. In example embodiments, a user may also define communication profiles specifying a channel and format (for example, SWIFT MTxxx messages by File) and assign them to one or more partner/recipients.

Embodiments of the present invention allow the user to display, edit, release, transfer, assign, unassign, reverse, confirm, or complete COs through the Correspondence Monitor. Example embodiments of the present invention further allow the user to monitor the correspondence life cycle by automatically matching (i.e., “reconciling”) incoming feedback messages from the partner/recipient (for example, a confirmation message or a message reporting an error and identifying missing data) to the corresponding transaction. In example embodiments, the user may define matching criteria, for example based on a unique transaction ID. Example embodiments further display the transaction status (for example, “Complete” or “Missing Data Error: [Description]”) in the Correspondence Monitor. If matching has been unsuccessful, then the user may manually match messages to their corresponding transactions.

Embodiments of the present invention also provide a mechanism for approving high-value deals. In example embodiments, the user may flexibly define “high-value” trades which require approval. If approval is required, the system waits for approval before sending correspondence.

Example embodiments of the present invention also archive correspondences in a Document Management System (DMS), which may be reviewed for error resolution (for example, if a partner requests missing data) or auditing (for example, SOX compliance). In example embodiments, the user may choose how long to preserve correspondences in the DMS.

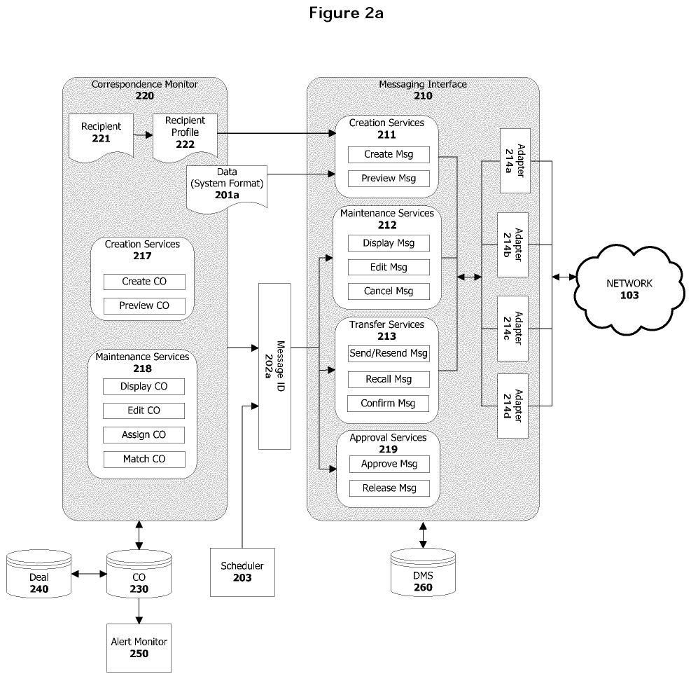

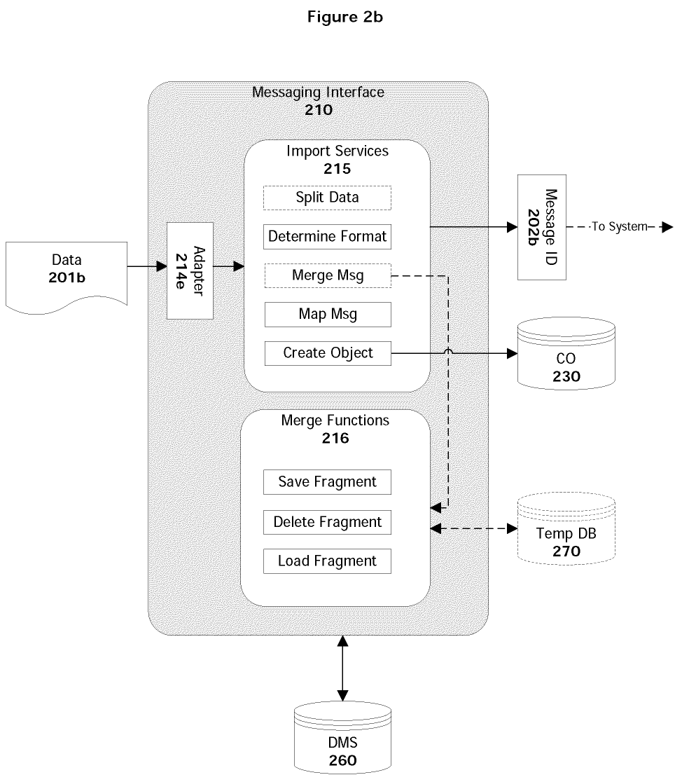

FIG. 2 illustrates an example system according to the present invention. The improved functionality of Correspondence Monitor 220 is shown in FIG. 2a. In an example embodiment, Correspondence Monitor 220 may be used not only to create and manage COs 230, but also to view and manage messages through Messaging Interface 210, and further to create and maintain recipient profiles 222.

An example embodiment of the present invention provides three modes for Correspondence Monitor 220 to create and manage COs 130: Assignment View, Match View, and Normal View. In Assignment View, the user may view or change assignments from COs 230 to Deals 240. That is, Assignment View presents the Deal 240, if any, to which each CO 230 is assigned, or it shows that a CO 230 is currently unassigned. The user may then assign, reassign, or unassign COs 230 to or from Deals 240. In Match View, the user may define matching criteria for COs 230 (as described above) and also view and change matching assignments. That is, a user may view matched and unmatched COs 230 and manually match or unmatch COs 230. In Normal View, Correspondence Monitor 220 displays the details for a CO 230 and its assigned Deal 240. It may also display the correspondence history for assigned Deal 240. In Normal View, a user may view, add, or edit CO details, including freeform notes, attached documents, and completion status.

In an example embodiment, Correspondence Monitor 220 may also provide an interface for the user to view and manage messages through the Messaging Interface 210. For example, a user may create and preview a message, send or resend a message, recall an undelivered message, or confirm a received message. A user may also approve an outgoing message, for example a high-value trade confirmation as described above, by manually releasing the message or marking it as approved.

In an example embodiment, the user may also create and edit profiles 222 and assign or unassign each profile to or from recipients 221. As described above, a profile defines the channel and format for correspondence functions sent to a set of recipients 221; each profile is assigned to one or more recipients.

FIG. 2a also shows the improved functionality of Messaging Interface 210 with respect to outgoing messages. These improvements are largely enabled by one or more Adapters 214, each of which implement sending or receiving functions over a given channel. In example embodiments, each Adapter 214 may be programmed to send and receive messages in different formats over its corresponding channel. For example, a File Adapter may be programmed to define and perform mapping for both SWIFT and PDF messages received and sent over the File channel. A user may build similar Adapters for other channels, for example a Fax Adapter. The Adapter 214 should allow the user to easily change mapping between the user's system data format and the message format defined by the recipient's profile. In an example embodiment, this mapping may be built and maintained through a drag-and-drop interface.

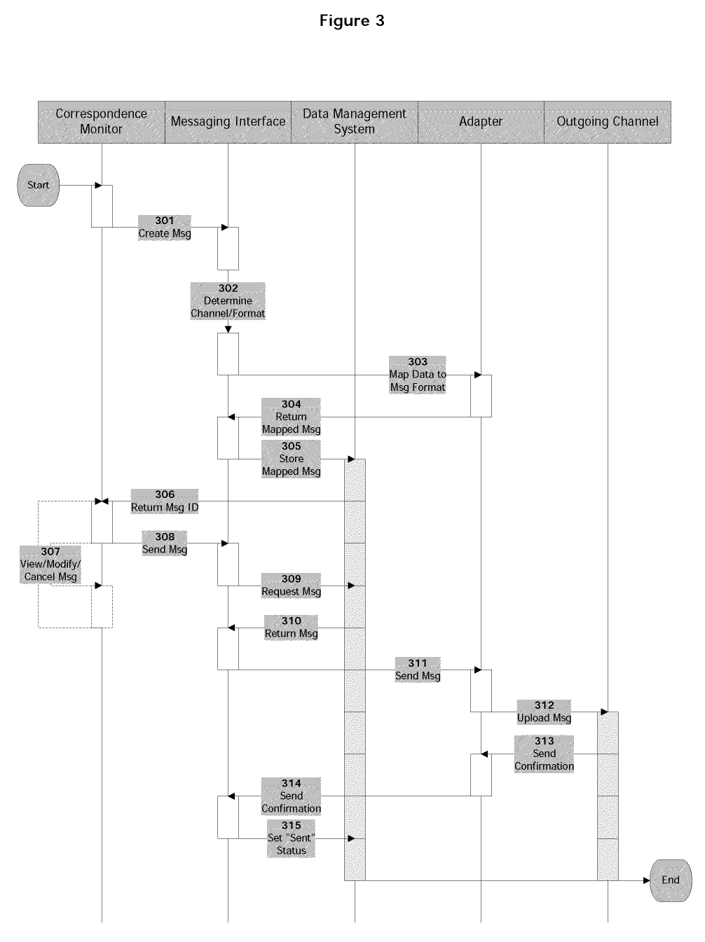

An example procedure for sending a message according to an embodiment of the invention is shown in FIG. 3. In step 301, Correspondence Monitor 220 requests that Messaging Interface 210 create an outgoing message. This request may include such parameters as the recipient 221, the recipient's profile 222, and the outgoing data 201a to be sent. The outgoing data 201a may be stored in the system format; it need not yet conform to the communication profile 222.

In step 302, Messaging Interface 210 determines the appropriate channel and format for the outgoing message. In example embodiments, the channel may be determined from the recipient 221, the profile 222, and the function of the outgoing data 201a. The format of the outgoing message may, in turn, be ascertained from the recipient 221, the function of the outgoing data 201a, and the determined channel.

In step 303, the appropriate Adapter 214 maps the outgoing data 201a to the format determined in step 302. For example, if Adapter 214a were a File Adapter containing mapping rules for SWIFT messages, and the recipient profile 222 specified sending SWIFT messages over a File channel, then Adapter 214a would map the outgoing data 201a to SWIFT formatting. The Adapter 214 returns the mapped message to the main Messaging Interface 210 in step 304.

In step 305, the Messaging Interface 210 stores the mapped message in DMS 260. In example embodiments, the mapped message is stored in a generic structure such as a binary file. In step 306, the DMS 260 returns a unique message ID 202a for the stored mapped message to Correspondence Monitor 220, possibly through an Adapter 214. In step 307, the user may optionally view, modify, or cancel the message through the Correspondence Monitor 220 as described above. In example embodiments, the Correspondence Monitor 220 accesses the message using the unique message ID it received in step 306.

In step 308, the Correspondence Monitor 220 requests that the Messaging Interface 210 send the message. In example embodiments, a user-defined event may trigger this request automatically, or the request may be made manually or by a Scheduler 203.

In step 309, Messaging Interface 210 requests the stored message from DMS 260, which returns the stored message to the Messaging Interface 210 in step 310.

In step 311, the Messaging Interface 210 requests that the appropriate Adapter send the message. In step 312, the Adapter transfers the message to the outgoing channel via Network 103. Returning to the above example, File Adapter 214a would upload the File containing the SWIFT message to the destination File server. The Adapter may receive a confirmation message from the outgoing channel in step 313 and relay the confirmation to the main Messaging Interface in step 314.

In step 315, the Messaging Interface sets a status of the message in DMS 260 to “Sent,” and the process ends. If the message later needs to be resent, then it may be retrieved from DMS 260, marked “Unsent,” and sent again following the process outlined in steps 307-315.

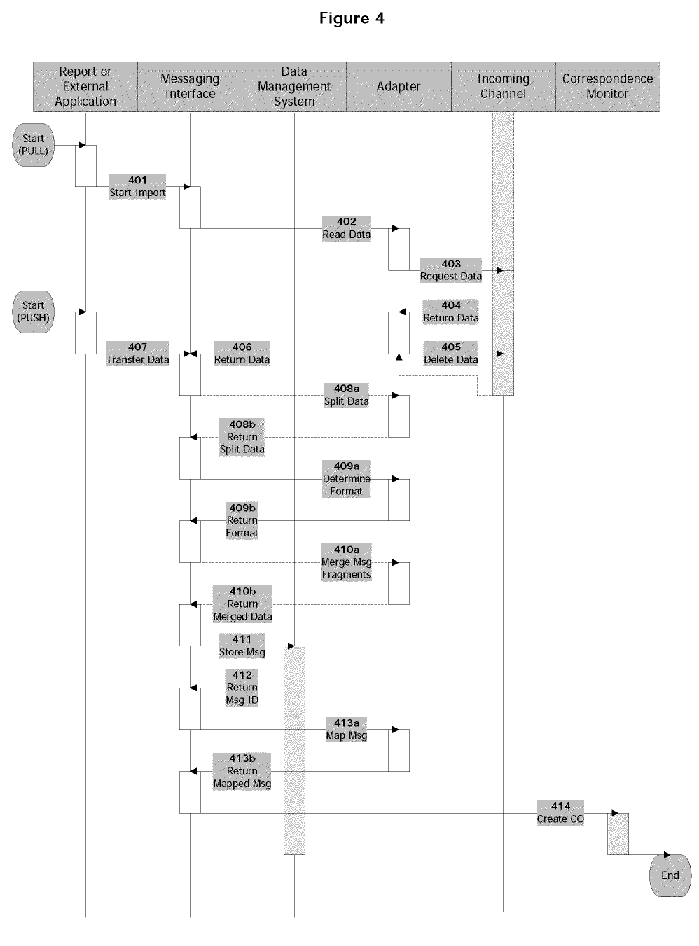

FIG. 2b shows the improved functionality of Messaging Interface 210 with respect to incoming messages. These improvements use the same Adapters 214 shown in FIG. 2a. An example procedure for receiving a message according to an embodiment of the invention is shown in FIG. 4.

The process begins by loading incoming data 201b into Messaging Interface 210. Either a “pull” method or a “push” method may accomplish this task. Under the “pull” method, an external application or report invokes Messaging Interface 210 in step 401 to start the import from a given channel. In example embodiments, this step may be initiated manually or by Scheduler 203. In step 402, Messaging Interface 210 requests that the appropriate Adapter 214 read the incoming data 201b. In example embodiments, the appropriate Adapter 214 is the Adapter corresponding to the channel from which the incoming data 201b is being pulled. For example, if Adapter 214e were the Fax Adapter, and the data 201b were being pulled from a Fax channel, then Adapter 214e would be the appropriate Adapter 214. In step 403, the Adapter 214 requests the incoming data 201b from a channel-specific (and possibly function- or profile-specific) location. In step 404, the incoming channel returns the data 201b to Adapter 214b. The Adapter 214 may then delete the data from the incoming channel or mark the data as downloaded, as shown in step 405. In step 406, Adapter 214 returns the incoming data 201b to the main Messaging Interface 210. Alternatively, under the “push” method, an external application or report transfers the incoming data 201b directly to Messaging Interface 210.

In step 408, the Messaging Interface 210 determines whether incoming data 201b contains more than one logical message. If so, then Messaging Interface 210 splits incoming data 201b into its logical message components.

In step 409, Messaging Interface 210 requests that Adapter 214 determine the format of the incoming message. In an embodiment, the incoming data header may indicate the message format. In another embodiment, the incoming channel may have provided the message format, for example in step 404.

In step 410, Messaging Interface 210 recognizes any message fragments (such as securities account statement messages sent from a depository bank or broker) in incoming data 201b, and Adapter 214 merges the fragments into logical messages. In example embodiments, the user may customize the fragment recognition and reconstruction logic used by Messaging Interface 210. Example embodiments may also store fragments in a temporary database 270 until they are successfully merged. Example embodiments may further maintain a list of incomplete fragments for error reporting, for example through Alert Monitor 250.

In step 411, Messaging Interface 210 stores the incoming message(s) in DMS 260. DMS 260 then returns a unique Message ID 202b to Messaging Interface 210.

In step 413, the appropriate Adapter 214 maps the incoming message from the format determined in step 409 into the system data structure and returns the formatted message to Messaging Interface 210. For example, if Adapter 214e were the Fax Adapter containing mapping rules for bitmap messages, and incoming data 201b contained bitmap messages received over the Fax channel, then Adapter 214e would map the incoming data to the system data structure and return the mapped message to Message Interface 210.

In step 414, Messaging Interface 210 creates a CO 130 from the mapped incoming message, and the process ends.

For purposes of illustration, the above example embodiments of the present invention largely concern a File channel. However, the embodiments may be used for other purposes as would be evident to one of skill in the art. For example, embodiments of the present invention may communicate over E-mail, Fax, Telephone, or Printer.

Likewise, those skilled in the art can appreciate from the foregoing description that the present invention can be implemented in a variety of forms. For example, the above embodiments may be used in various combinations with and without each other. Therefore, while the embodiments of the present invention have been described in connection with particular examples thereof, the above embodiments are for illustration purposes only and are not meant to limit the scope of the present invention. Other modifications will become apparent to the skilled practitioner upon a study of the present application.

What is claimed is:

1. A method for sending data from a treasury system to a recipient, comprising using a processor to perform the steps of:
selecting an outgoing channel and an outgoing message format based on the data and a predefined profile associated with the recipient which specifies the outgoing channel and the outgoing message format that correspond to the recipient;
creating an outgoing message by using predefined mapping rules to map the data to the outgoing message format; and
transferring the outgoing message to the outgoing channel through an adapter associated with the outgoing channel, which is programmed to perform predefined sending functions corresponding to the outgoing message format.

2. The method according to claim 1, wherein the profile is customizable by a user.

3. The method according to claim 1, wherein the mapping rules are customizable by a user.

4. The method according to claim 1, wherein the sending functions are customizable by a user.

5. The method according to claim 1, wherein the adapter is further programmed to perform second predefined sending functions corresponding to a second outgoing message format.

6. The method according to claim 5, wherein the second sending functions are customizable by a user.

7. The method according to claim 1, further comprising:
storing the outgoing message in a data management system until a predetermined event occurs; and
receiving a unique message identifier associated with the stored outgoing message from the data management system.

8. The method according to claim 7, wherein the event is customizable by a user.

9. The method according to claim 7, wherein the event occurs when a predetermined period of time elapses.

10. The method according to claim 9, wherein the period of time is customizable by a user.

11. The method according to claim 7, further comprising setting a status of the stored outgoing message to indicate that the outgoing message has been sent.

12. The method according to claim 7, further comprising:
retrieving the stored outgoing message from the data management system; and
displaying the retrieved outgoing message.

13. The method according to claim 7, further comprising:
retrieving the stored outgoing message from the data management system; and
modifying the retrieved outgoing message.

14. The method according to claim 7, further comprising:
retrieving the stored outgoing message from the data management system; and
retransferring the retrieved outgoing message to the outgoing channel.

15. The method according to claim 7, further comprising, if a transaction associated with the outgoing message exceeds a predefined value limit, soliciting user approval before transferring the outgoing message to the outgoing channel.

16. The method according to claim 15, wherein the value limit is customizable by a user.

17. The method according to claim 1, wherein transferring the outgoing message to the outgoing channel is initiated by a predefined event.

18. The method according to claim 17, wherein the event is customizable by a user.

19. The method according to claim 1, wherein transferring the outgoing message to the outgoing channel is initiated by a scheduler.

20. The method according to claim 1, further comprising receiving a confirmation message from the outgoing channel.

21. A method for performing predefined functions based on data received into a treasury system, the data comprising logical messages, the method comprising using a processor to perform the steps of:
receiving the data into a messaging interface within the treasury system;
extracting each of the logical messages from the received data;
selecting an incoming message format based on the received data;
creating an incoming message from each extracted logical message by using predefined mapping rules associated with the incoming message format to map the logical message from the incoming message format to a predefined treasury system format; and
performing the functions based on each incoming message.

22. The method according to claim 21, wherein the functions are customizable by a user.

23. The method according to claim 21, wherein receiving the data into the messaging interface comprises retrieving the data from a specified incoming channel through an adapter associated with the incoming channel, which is programmed to perform predefined receiving functions corresponding to the incoming message format.

24. The method according to claim 23, wherein the receiving functions are customizable by a user.

25. The method according to claim 23, wherein the adapter is further programmed to perform second predefined receiving functions corresponding to a second incoming message format.

26. The method according to claim 25, wherein the second receiving functions are customizable by a user.

27. The method according to claim 23, wherein receiving the data into the messaging interface further comprises deleting the data from the incoming channel.

28. The method according to claim 23, wherein receiving the data into the messaging interface further comprises setting a status of the data in the incoming channel to indicate that the data has been retrieved.

29. The method according to claim 21, wherein the mapping rules are customizable by a user.

30. The method according to claim 21, wherein the treasury system format is customizable by a user.

31. The method according to claim 21, wherein performing the functions comprises creating a correspondence object based on the incoming message.

32. The method according to claim 21, wherein performing the functions comprises settling a transaction associated with the incoming message.

33. The method according to claim 21, further comprising using predefined recognition logic to identify message fragments within the received data.

34. The method according to claim 33, wherein the recognition logic is customizable by a user.

35. The method according to claim 33, further comprising using predefined reconstruction logic to merge two or more message fragments into a logical message.

36. The method according to claim 35, wherein the reconstruction logic is customizable by a user.

37. The method according to claim 33, further comprising storing each message fragment in a database until it is merged into a logical message.

38. The method according to claim 33, further comprising maintaining a list of message fragments that have not been merged into a logical message.

39. The method according to claim 21, further comprising:
storing the logical message in a data management system until a predetermined event occurs; and
receiving a unique message identifier associated with the stored logical message from the data management system.

40. The method according to claim 39, wherein the event is customizable by a user.

41. The method according to claim 39, wherein the event occurs when a predetermined period of time elapses.

42. The method according to claim 41, wherein the period of time is customizable by a user.

43. The method according to claim 21, further comprising using predefined matching criteria to match the logical message with a transaction associated with the incoming message.

44. The method according to claim 43, wherein the matching criteria are customizable by a user.

45. A system for sending data from a treasury system to a recipient, comprising:
a display;
a processor;
a computer-readable storage medium storing instructions to be executed by the processor, which instructions, when executed, perform a method comprising:
selecting an outgoing channel and an outgoing message format based on the data and a predefined profile associated with the recipient which specifies the outgoing channel and the outgoing message format that correspond to the recipient;
creating an outgoing message by using predefined mapping rules to map the data to the outgoing message format; and
transferring the outgoing message to the outgoing channel through an adapter associated with the outgoing channel, which is programmed to perform predefined sending functions corresponding to the outgoing message format.

46. A system for performing predefined functions based on data received into the system, the data comprising logical messages, comprising:
a display;
a processor;
a computer-readable storage medium storing instructions to be executed by the processor, which instructions, when executed, perform a method comprising:
receiving the data into a messaging interface within the treasury system;
extracting each of the logical messages from the received data;
selecting an incoming message format based on the received data;
creating an incoming message from each extracted logical message by using predefined mapping rules associated with the incoming message format to map the logical message from the incoming message format to a predefined treasury system format; and
performing the functions based on each incoming message.
